(19) United States
(12) Patent Application Publication
(10) Pub. No.: US 2014/0121839 A1
(43) Pub. Date: May 1, 2014

(54) NUMERICAL CONTROL APPARATUS

(71) Applicants: Sachio Hanya, Tokyo (JP); Kenji Nishiwaki, Tokyo (JP)

(72) Inventors: Sachio Hanya, Tokyo (JP); Kenji Nishiwaki, Tokyo (JP)

(73) Assignee: MITSUBISHI ELECTRIC CORPORATION, Chiyoda-ku, Tokyo (JP)

(21) Appl. No.: 14/006,176

(22) PCT Filed: Oct. 30, 2012
(86) PCT No.: PCT/JP2012/077953

§ 371 Date: Sep. 19, 2013

(51) Int. Cl. G05B 19/4093

(52) U.S. Cl. CPC G05B 19/40938
USPC 700/275

(57) ABSTRACT

A numerical control apparatus includes a table storing unit that stores a table, in which a command code related to a fixed cycle in a machining program and a subprogram for performing processing in accordance with the command code are registered, a command execution unit that reads the subprogram corresponding to the command code read from the machining program from the table and performs processing in accordance with the subprogram, and a display unit that is an interface that accepts a change to a registered content of the table, in which the interface accepts a macro setting to perform macro processing with respect to the subprogram of the machining program in accordance with foreign specifications, which are different from native specifications, with which the command execution unit can normally recognize a content of processing specified by the command code.

### FIELD

The present invention relates to a numerical control (Numerical Control; NC) apparatus.

### BACKGROUND

Some conventional NC apparatuses store a table that associates command codes (for example, G codes) that are related to fixed cycles with subprograms. When the NC apparatus reads a G code related to a fixed cycle in a machining program input by a user, the NC apparatus reads the subprogram corresponding to the G code. The NC apparatus then performs a process in accordance with the read subprogram.

In the NC apparatuses that are manufactured by different manufacturers, commands in accordance with different specifications are used for the same function in some cases. For example, a setting of an argument in a G code is different in some cases for each NC apparatus. When a G code that is not present in the stored table is read or when a G code in which the setting of an argument is different is read, the conventional NC apparatuses perform error processing and stops execution of the subprogram. A machining program in accordance with specifications different from those that the NC apparatus originally has is used after the user rewrites the G code or the argument thereof.

To overcome this problem, for example, a technology is proposed in Patent Literature 1 that enables commands in accordance with specifications different from the specifications of the NC apparatus to be applied to the NC apparatus by performing a conversion process of converting the commands into machine language.

### CITATION LIST

### Patent Literature

Patent Literature 1: Japanese Patent Application Laid-open H11-143511

### SUMMARY

### Technical Problem

The numerical control apparatus disclosed in Patent Literature 1 converts commands in accordance with specifications different from the specifications of the NC apparatus into machine language and does not enable command codes in accordance with different specifications to be converted into each other. Conversion of command codes into machine language is processing specific to a system. When machining is performed under the same setting both during machining by each fixed cycle and during normal machining other than the fixed cycles, it becomes difficult to perform machining under optimum conditions in each fixed cycle.

The present invention is achieved in view of the above and has an object to obtain a numerical control apparatus that enables machining to be performed under optimum conditions in each fixed cycle by using a machining program in accordance with different specifications.

### Solution to Problem

In order to solve the above problems and achieve the object, the present invention includes a table storing unit that stores a table, in which a command code related to a fixed cycle in a machining program and a subprogram for performing processing in accordance with the command code are registered, a command execution unit that reads the subprogram corresponding to the command code read from the machining program from the table and performs processing in accordance with the subprogram, and an interface that accepts a change to a registered content of the table, in which the interface accepts a macro setting to perform macro processing with respect to the subprogram of the machining program in accordance with foreign specifications, which are different from native specifications, with which the command execution unit can normally recognize a content of processing specified by the command code.

### Advantageous Effects of Invention

The numerical control apparatus according to the present invention can convert a machining program from foreign specifications to the native specifications by performing macro processing on a subprogram. A user can use a machining program in accordance with foreign specifications in the numerical control apparatus without separately correcting the machining program. The numerical control apparatus can perform machining under optimum conditions in each fixed cycle by appropriately accepting the editing of a macro setting for each processing in a fixed cycle. Consequently, the numerical control apparatus can realize machining under optimum conditions in each fixed cycle by using a machining program in accordance with different specifications.

### BRIEF DESCRIPTION OF DRAWINGS

FIG. 1 is a block diagram illustrating the schematic configuration of a numerical control apparatus according to an embodiment of the present invention.

FIG. 2 is a diagram illustrating an example of a display on an interface screen included in a display unit.

FIG. 3 is a flowchart explaining the procedure of the operation performed by the NC apparatus.

FIG. 4 is a diagram illustrating an example of a machining program and a macro setting for each of the pre-processing, execution processing, post-processing, and exception processing.

### DESCRIPTION OF EMBODIMENT

An embodiment of a numerical control apparatus according to the present invention will be described in detail below with reference to the drawings. This invention is not limited to this embodiment.

### Embodiment

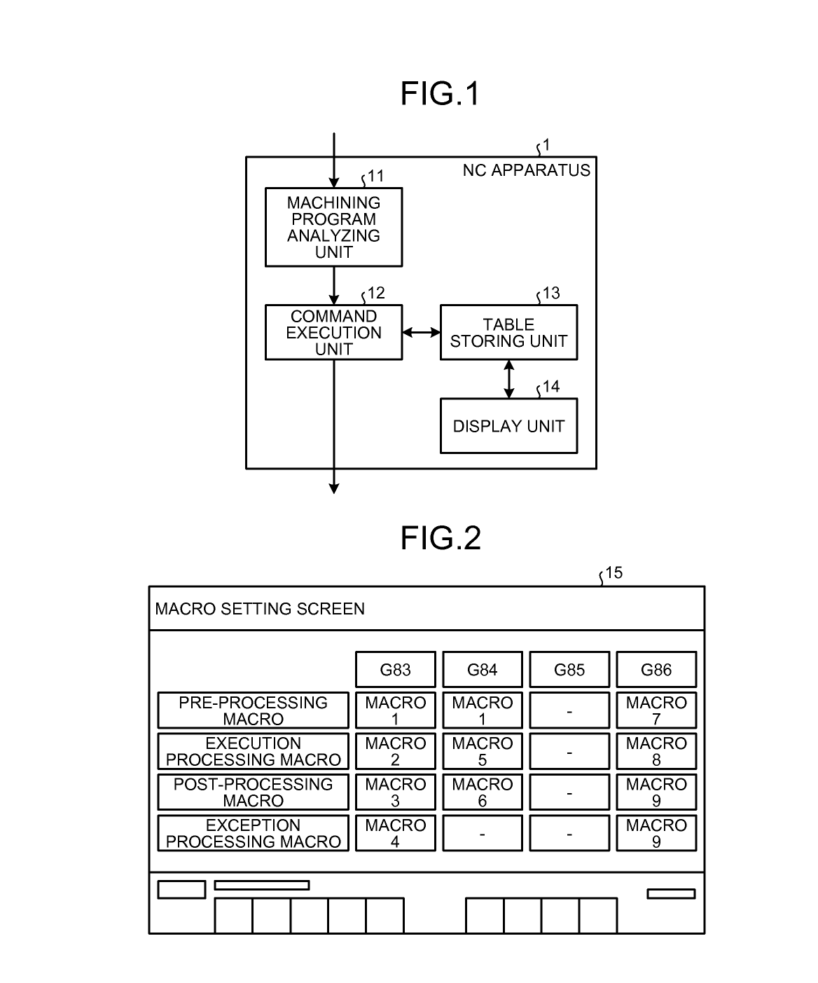

FIG. 1 is a block diagram illustrating the schematic configuration of a numerical control apparatus according to the embodiment of the present invention. A numerical control (Numerical Control; NC) apparatus 1 controls the driving of a machine tool (not illustrated) that performs, for example, drilling and the like. The NC apparatus 1 includes a machining program analyzing unit 11, a command execution unit 12, a table storing unit 13, and a display unit 14.

The machining program analyzing unit 11 reads a machining program input to the NC apparatus 1 and analyzes the machining program. The command execution unit 12 performs processing in accordance with a command analyzed by the machining program analyzing unit 11. The table storing unit 13 stores a table therein.

The table stored in the table storing unit 13 is a correspondence table in which command codes related to fixed cycles in a machining program and subprograms are registered such that they are associated with each other. The NC apparatus 1 distinguishes command codes related to fixed cycles from other command codes by registering the command codes related to the fixed cycles in the table in the table storing unit 13. The command code is, for example, a G code.

The command execution unit 12 reads a subprogram corresponding to a command code that is read from a machining program from the table in the table storing unit 13. The command execution unit 12 performs processing in accordance with the subprogram. The display unit 14 functions as an interface that accepts changes to the content of the table stored in the table storing unit 13.

The NC apparatus 1 accepts an input of a machining program in accordance with foreign specifications in addition to a machining program in accordance with the native specifications. The native specifications are specifications for a machining program with which the command execution unit 12 can normally recognize the content of the processing specified by a command code. The foreign specifications are specifications that are different from the native specifications. For example, a machining program in accordance with the foreign specifications is a machining program generated to adapt to NC apparatuses other than the NC apparatus 1 according to the present embodiment.

FIG. 2 is a diagram illustrating an example of a display on an interface screen included in the display unit. The display unit 14 includes an interface screen 15. The display unit 14 accepts, via the interface screen 15, macro settings to perform macro processing with respect to subprograms of a machining program in accordance with the foreign specifications. The macro settings accepted via the interface screen 15 are registered in the table stored in the table storing unit 13. The interface screen 15 displays macro settings registered for each command code as a macro setting screen.

The display unit 14 can accept a macro setting for each of the pre-processing and execution processing of machining, the post-processing performed when machining finishes normally, and the exception processing performed when machining finishes abnormally, in a fixed cycle.

A G code is represented by a character “G” and a two-digit number. The “pre-processing macro” column indicates macro settings that are registered by a user for the pre-processing before machining. The “execution processing macro” column indicates macro settings that are registered by a user for the execution processing of machining. The “post-processing macro” column indicates macro settings that are registered by a user for the post-processing performed when machining finishes normally. The “exception processing macro” column indicates macro settings that are registered by a user for the exception processing performed when machining finishes abnormally. In each of the “pre-processing macro”, “execution processing macro”, “post-processing macro”, and “exception processing macro” columns, “−” indicates that a macro setting is not made and indicates a setting in which special processing is not performed.

In the example illustrated in FIG. 2, for the G code “G83”, “macro 1” is registered as the pre-processing macro, “macro 2” is registered as the execution processing macro, “macro 3” is registered as the post-processing macro, and “macro 4” is registered as the exception processing macro. When the command execution unit 12 refers to the macro settings of the G code “G83”, the command execution unit 12 executes “macro 1” as the pre-processing macro, “macro 2” as the execution processing macro, “macro 3” as the post-processing macro, and “macro 4” as the exception processing macro.

For the G code “G84”, “macro 1” is registered as the pre-processing macro, “macro 5” is registered as the execution processing macro, and “macro 6” is registered as the post-processing macro. The exception processing macro is not set. For the G code “G85”, none of the pre-processing macro, execution processing macro, post-processing macro, and exception processing macro are set. For the G code “G85”, normal processing in accordance with the G code “G85” is performed.

For the G code “G86”, “macro 7” is registered as the pre-processing macro, “macro 8” is registered as the execution processing macro, “macro 9” is registered as the post-processing macro, and “macro 9” is registered as the exception processing macro. For the G code “G86”, the NC apparatus 1 performs the same operation of “macro 9” both in the post-processing performed when machining finishes normally and the exception processing performed when machining finishes abnormally.

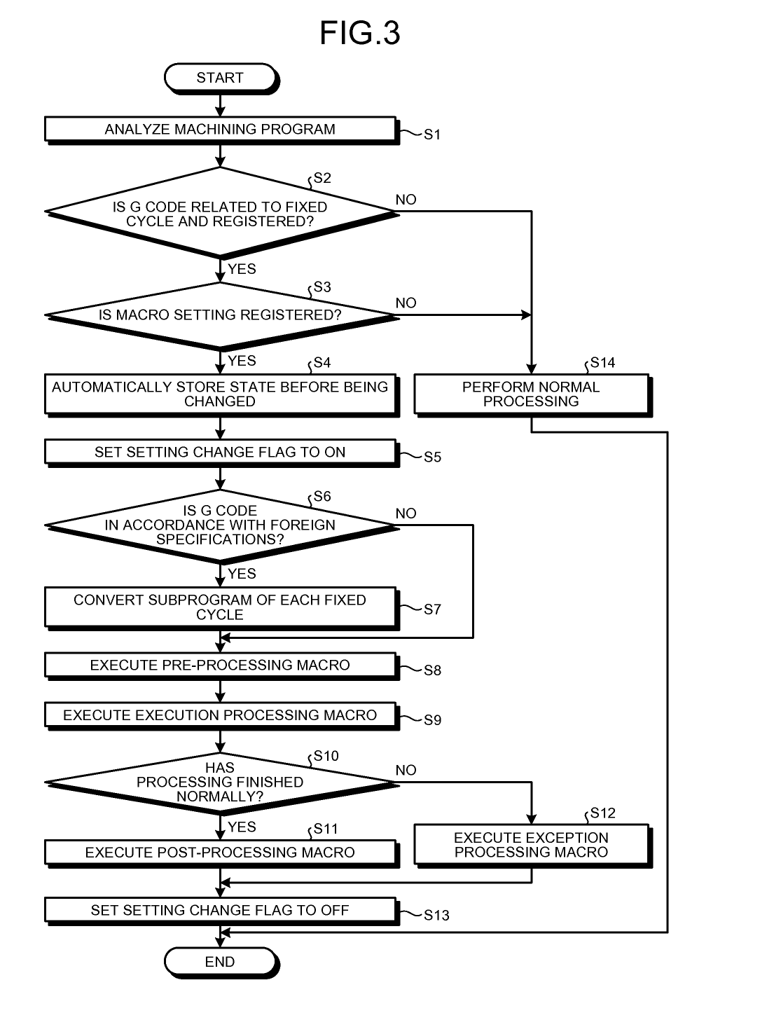

FIG. 3 is a flowchart explaining the procedure of the operation performed by the NC apparatus. The machining program analyzing unit 11 reads a machining program input to the NC apparatus 1 and analyzes the machining program (Step S1). The command execution unit 12 determines whether a G code read from the machining program is related to a fixed cycle and is registered in the table storing unit 13 (Step S2).

When the G code read from the machining program is not related to a fixed cycle and is not registered in the table storing unit 13 (No in Step S2), the command execution unit 12 performs normal processing in accordance with the read G code (Step S14).

When the G code read from the machining program is related to a fixed cycle and is registered in the table storing unit 13 (Yes in Step S2), the command execution unit 12 determines whether macro settings for any of the pre-processing, execution processing, post-processing, and exception processing are registered (Step S3). When none of the macro settings for any of the pre-processing, execution processing, post-processing, and exception processing are registered (No in Step S3), the command execution unit 12 performs normal processing in accordance with the read G code (Step S14).

For example, in the case of the example illustrated in FIG. 2, the G code “G85” is registered in the table storing unit 13 as a code related to a fixed cycle; however, none of the micro settings for the pre-processing, execution processing, post-processing, and exception processing are registered. Therefore, the command execution unit 12 performs normal processing in accordance with the G code “G85”.

When any of the micro settings for the pre-processing, execution processing, post-processing, and exception processing are registered (Yes in Step S3), the command execution unit 12 automatically stores, as a backup, the state of the current modal, parameters, and the like, which is the setting content related to a subprogram before being changed in accordance with a macro setting (Step S4). The command execution unit 12 then sets the setting change flag to on (Step S5). The setting change flag is a flag that indicates whether the setting of a modal, parameters, and the like has changed.

For example, in the case of the example illustrated in FIG. 2, the G code “G83” is registered in the table storing unit 13 as a code related to a fixed cycle and the macro settings for all the pre-processing, execution processing, post-processing, and exception processing are registered. The command execution unit 12 stores the setting of the current modal, parameters, and the like for the G code “G83” and sets the setting change flag to on.

The command execution unit 12 determines whether the G code read from the machining program is in accordance with the foreign specifications on the basis of the analysis result obtained in Step S1 (Step S6).

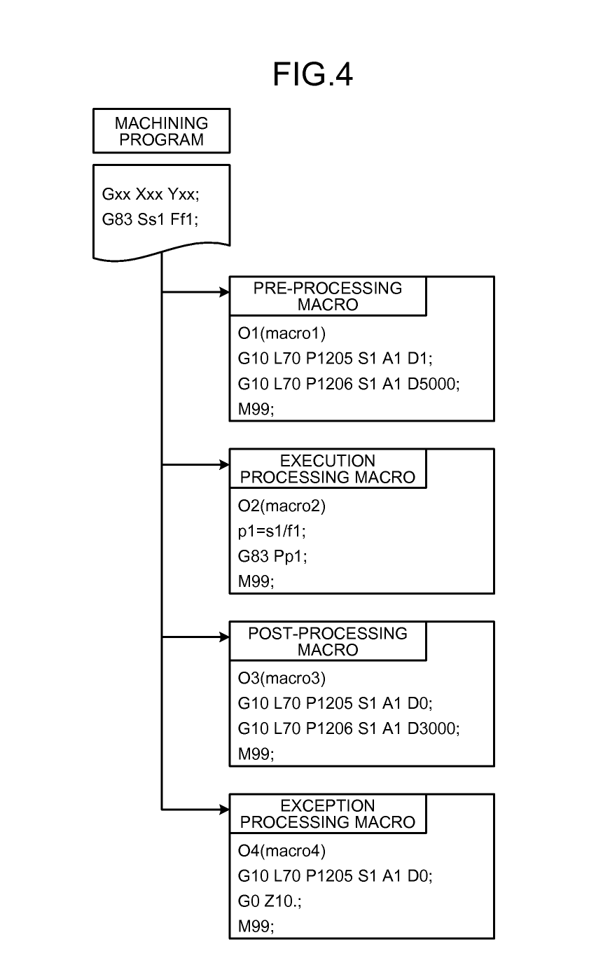

FIG. 4 is a diagram illustrating an example of a machining program and a macro setting for each of the pre-processing, execution processing, post-processing, and exception processing. The machining program illustrated in FIG. 4 includes the G code “G83” in accordance with the specifications A, which are foreign specifications. The address of a G code in accordance with the specifications A is specified, for example, by using “S” and “F”.

Meanwhile, the specifications B are set as the native specifications in the NC apparatus 1. The address of a G code in accordance with the specifications B is specified, for example, by using “P”. “S”, “F”, and “P” satisfy the relationship P=S/F.

The command execution unit 12 checks the specifications of a G code on the basis of the analysis result obtained in Step S1. The specifications are determined from the letters used for the address that is the argument in the G code. When the G code is in accordance with the foreign specifications (Yes in Step S6), the command execution unit 12 converts the subprogram corresponding to the G code of each fixed cycle into a subprogram in accordance with the native specifications (Step S7). The information on the argument that is referred to for distinguishing the specifications and the information on the method of converting a subprogram into that in accordance with different specifications can be, for example, registered in the NC apparatus 1 in advance by a user.

In the example illustrated in FIG. 4, because the address is specified by using “S” and “F”, the command execution unit 12 determines that the G code analyzed in Step S1 is a code in accordance with the specifications A. The command execution unit 12 converts the address specified by using “S” and “F” in the G code “G83” in accordance with the specifications A into an address specified by using “P”, in accordance with the specifications B. In this manner, when a command code read from a machining program is in accordance with the foreign specifications and a macro setting is registered in the table storing unit 13, the command execution unit 12 converts the subprogram corresponding to the command code in accordance with the macro setting.

When the G code is not in accordance with the foreign specifications but is in accordance with the native specifications (No in Step S6), the command execution unit 12 does not perform the conversion in Step S7 and moves the process to Step S8.

The command execution unit 12 executes the pre-processing macro set from the interface screen 15 for the G code analyzed in Step S1 (Step S8). For example, for the G code “G83”, “macro 1” registered as the pre-processing macro is invoked. The command execution unit 12, for example, changes the mode of “G10L70” from a post-interpolation acceleration/deceleration to a pre-interpolation acceleration/deceleration by executing “macro 1”. The display unit 14, which is an interface, can accept changes to the content of the pre-processing due to the macro setting on the interface screen 15.

The NC apparatus 1 can optimize the setting of the mode and parameters in each fixed cycle by appropriately editing the macro settings. The NC apparatus 1 can realize highly efficient machining by optimizing the setting for a target fixed cycle.

The command execution unit 12 executes the execution processing macro set from the interface screen 15 for the G code analyzed in Step S1 (Step S9). For example, for the G code “G83”, “macro 2” registered as the execution processing macro is invoked. In “macro 2”, the command execution unit 12 converts the address specified by using “S” and “F” in accordance with the specifications A into the address specified by using “P” in accordance with the specifications B.

The command execution unit 12 executes the command of the G code “G83” after calculating the address specified by using “P”. At this point, the command execution unit 12 reads the setting change flag described above. When the read setting change flag is on, the command execution unit 12 does not perform each macro processing, i.e., the pre-processing, execution processing, post-processing, and exception processing, on the G code “G83” in the execution processing macro. Consequently, the command execution unit 12 prevents a looping, i.e., prevents the processing of the pre-processing macro from being performed again on the G code “G83” in the execution processing macro.

The command execution unit 12 determines whether the processing by the fixed cycle has finished normally (Step S10). When the processing by the fixed cycle has finished normally, for example by the G code “G80” or the like (Yes in Step S10), the command execution unit 12 executes the post-processing macro set via the interface screen 15 (Step S11).

For example, for the G code “G83”, “macro 3” registered as the post-processing macro is invoked. In “macro 3”, the command execution unit 12 performs a process of returning the setting content of the modal, parameters, and the like to the state before the change, which is automatically stored in Step S4, for the case where the processing by the command code finishes normally.

When the processing by the fixed cycle did not finish normally, due to, for example, a power shutdown, reset, or the like (No in Step S10), the command execution unit 12 executes the exception processing macro set via the interface screen 15 (Step S12).

For example, for the G code “G83”, “macro 4” registered as the exception processing macro is invoked. In “macro 4”, the command execution unit 12 performs a process of returning the setting content of the modals, parameters, and the like to the state before the change, which is automatically stored in Step S4, for the case where the processing by the command code did not finish normally. In “macro 4”, the command execution unit 12 performs a process of, for example, returning a machine tool that has stopped halfway to a predetermined position, for example, the reference position to start machining. Consequently, the command execution unit 12 recovers from the stopped state that is due to an abnormality.

Next to Step S11 or Step S12, the command execution unit 12 sets the setting change flag to off (Step S13) and ends the conversion of the fixed cycle program.

The NC apparatus 1 can convert a machining program from the foreign specifications to the native specifications by performing macro processing on a subprogram. A user can use a machining program in accordance with the foreign specifications in the NC apparatus 1 without separately correcting the machining program. The NC apparatus 1 can perform machining under optimum conditions in each fixed cycle by appropriately accepting the editing of a macro setting for each processing in a fixed cycle. Consequently, the NC apparatus 1 can realize machining under optimum conditions in each fixed cycle by using a machining program in accordance with different specifications.

### REFERENCE SIGNS LIST

1 numerical control (NC) apparatus, 11 machining program analyzing unit, 12 command execution unit, 13 table storing unit, 14 display unit, 15 interface screen

1. A numerical control apparatus comprising:
a table storing unit that stores a table, in which a command code related to a fixed cycle in a machining program and a subprogram for performing processing in accordance with the command code are registered;
a command execution unit that reads the subprogram corresponding to the command code read from the machining program from the table and performs processing in accordance with the subprogram; and
an interface that accepts a change to a registered content of the table, wherein
the interface accepts a macro setting to perform macro processing with respect to the subprogram of the machining program in accordance with foreign specifications, which are different from native specifications, with which the command execution unit is capable of normally recognizing a content of processing specified by the command code.

2. The numerical control apparatus according to claim 1, wherein when the command code read from the machining program is in accordance with the foreign specifications and the macro setting is made for the command code, the command execution unit converts the subprogram corresponding to the command code into that in accordance with the native specifications.

3. The numerical control apparatus according to claim 1, wherein the interface is a display unit that includes an interface screen that displays the macro setting for each command code.

4. The numerical control apparatus according to claim 1, wherein the interface is capable of accepting the macro setting for each of pre-processing and execution processing of machining, post-processing performed when the machining finishes normally, and exception processing performed when the machining finishes abnormally, in the fixed cycle.

5. The numerical control apparatus according to claim 4, wherein the interface is capable of accepting a change to a content of the pre-processing due to the macro setting.

6. The numerical control apparatus according to claim 4, wherein the command execution unit stores a setting content related to the subprogram before being changed in accordance with the macro setting in the pre-processing, and returns the setting content to a state before being changed in the post-processing and the exception processing.

7. The numerical control apparatus according to claim 4, wherein in the exception processing, the command execution unit returns a machine tool to a reference position to start machining.
